(19) United States
(12) Patent Application Publication
(10) Pub. No.: US 2006/0132836 A1
(43) Pub. Date: Jun. 22, 2006

(54) Method and apparatus for re-sizing image data

(76) Inventor: Christopher R. Coyne, New York, NY (US)

Correspondence Address: FROMMER LAWRENCE & HAUG, 745 FIFTH AVENUE- 10TH FL., NEW YORK, NY, 10151, US

(21) Appl. No.: 11/018,052

(22) Filed: Dec. 21, 2004

(51) Int. Cl. G06F 3/12

(52) U.S. Cl. 358/1.15

(57) ABSTRACT

A method and apparatus that enables a user to access image data, typically via a network, such as the Internet, and enlarge or reduce a selected portion of the image data. The re-sized image data can be printed, stored or transmitted to another location. The re-sizing may be implemented by a server device, client device or combination of the two. Image data is displayed at a terminal, for example at a user terminal, and a mark-up language template is overlayed on at least a portion of the image data. The template permits viewing of the portion of the image data. Next at least two parameters of the template are selected, indicating desired dimensions of the image data to be re-sized. The selected parameters are transmitted to a remote location where the selected image data is processed to generate a representation of the portion of the image data, which is transmitted to the user.

### BACKGROUND

1. Field of the Invention

This invention relates generally to re-sizing image data. More particularly, the present invention relates to receiving user input for determining desired dimensions for image data that is to be re-sized.

2. Background Discussion
Conventional image data manipulation techniques enable users to capture and transmit image data using a user terminal, such as a personal computer (PC).

For example, U.S. Pat. No. 6,298,157, issued to Wilensky, entitled, “Locating and Aligning Embedded Images” relates to automating the task of locating a photograph or other image that is embedded within a larger image. An edge curve is found that approximates the perimeter of the embedded image and from the edge curve the rectangle of the embedded image, or a rectangle covering the embedded image, is calculated by processing density profiles of the edge curve taken along two axes. Both location and orientation of an embedded image can be calculated. The location of the four corners of a rectangular embedded image can be calculated, which enables automatic cropping and rotation of the embedded image, even if fewer than all four corners are visible. A rectangle covering the image can be calculated, including a rectangle aligned with the axes of a larger embedding image such as is created when scanning a small photograph on a flatbed scanner. This patent is herby incorporated by reference in its entirety herein.

Also, U.S. Pat. No. 5,974,189, issued to Nicponski, entitled, “Method and Apparatus of Modifying Electronic Image Data” relates to an electronic reproduction apparatus with a modeling routine that identifies a portion of an electronic image to be modified; defines an optical axis, a projection point, a density contour shape and a density gradient profile. Modified image data values are calculated based on the optical axis, projection point, density contour shape and density gradient profile. These modified image data values are applied to the portion of the electronic image to be modified. The modified image data is calculated using a cubic spline interpolation. This patent is herby incorporated by reference in its entirety herein.

Thirdly, U.S. Pat. No. 6,144,974, issued to Gartland, entitled, “Automated Layout of Content in a Page Framework” relates to repositioning a content object on a page in response to a request to change the page framework associated with the page. The method includes receiving a user request to change the page framework. The current page framework information associated with the page is retrieved including a description for each framework member in the current page framework. Alignment data for the content object is derived by determining if any edge of the content object aligns with a framework member. Thereafter, the page layout is redefined according to the user request. Finally, the content object is repositioned on the redefined page based on the alignment data. This patent is herby incorporated by reference in its entirety herein.

However, the above-described techniques do not adequately address the needs of users who desire flexibility and the ability to customize re-sizing image data to their particular wishes. Thus, it would be an advancement in the state of the art to permit a user to selectively determine dimensions of image data displayed using a network, such as the Internet.

### BRIEF SUMMARY OF THE INVENTION

The present invention is directed toward a method, apparatus and system that enables a user to access image data, typically via a network, such as the Internet, and manipulate the data to generate a representation. The manipulation may include, for example, enlarging or reducing a selected portion of the image data, “moving” a selected portion of the image data, such as a “cut and paste” operation, or any combination of enlarging, reducing or moving selected data. The representation can be printed, stored or transmitted to another location. The present invention may be implemented by a server device or a server device that is operably coupled and working in conjunction with a client device.

Accordingly, one embodiment of the present invention relates to a method for manipulating image data. Image data is displayed at a terminal, for example a user terminal, and a mark-up language template is overlayed on at least a portion of the image data. The template, which is typically transparent, translucent or opaque, or a combination, permits viewing of the portion of the image data. Next, at least two parameters of the template are selected, indicating dimensions. The selected parameters are transmitted to a remote location. A representation of the portion of the image data is received at the user location.

Another embodiment of the present invention relates to the embodiment described above and, further, approving, at a user location, the representation.

Yet another embodiment of the present invention relates to the embodiment described above and, further, approving, at a user location, the selected parameters. In the event the selected parameters are not correct, or the user desires to make other selections, the parameters may be reselected and the reselected parameters are transmitted to the remote location. A second representation of the portion of the image data, which represents the reselected parameters, is then received at the user location.

Yet another embodiment of the present invention relates to a method for manipulating image data. The method includes accessing image data at a user location and overlaying a template on the image data. A first position of the template is specified and a second position of the template is specified. Signals indicative of the specified first position and the specified second position are transmitted to a processing location. A representation of the image data, generated as a function of the specified first position and the specified second position, is received at the user location.

Yet a further embodiment of the present invention relates to the method above and, further, approving, at a user location, the first and second specified positions.

Yet another embodiment of the present invention relates to a method for manipulating image data, which includes receiving, from a remote location, image data with at least two indications that have been indicated using a template. Portions of the image data are identified as a function of the indications and a representation of the image data is generated by modifying dimensions of the identified portions.

Yet another embodiment of the present invention relates to the method above and, further, transmitting the representation to a remote location, which could be designated by a user or preprogrammed.

### BRIEF DESCRIPTION OF THE DRAWINGS

FIG. 1 shows a network environment adapted to support the present invention.

FIG. 2 illustrates a processing apparatus adapted to store and process data related to the present invention.

FIG. 3 illustrates a communication appliance shown in FIG. 1.

FIG. 4 is an algorithm, executable at a processing apparatus, for manipulating selected image data.

FIG. 5 is an algorithm, executable at a communication appliance, for manipulating selected image data.

FIGS. 6A and 6B show selected portions of image data.

FIG. 7 shows an example of re-sized data.

### DETAILED DESCRIPTION OF THE INVENTION

This invention provides an apparatus, method and system to enable manipulating image data, for example, reducing (cropping), enlarging and/or moving picture data, or image data, displayed on a web page or other providing medium. The desire to resize a graphic is a common one, especially, for example, on websites that offer users the ability to maintain digital photo albums, arrange for physical printing of digital photographs, store profiles, host web pages, match with other users, retrieve image data, upload pictures or manage photos.

Specifically, the present invention enables a user to re-size an image on a static web page that they retrieve from a web site, according to parameters that the user selects. Also, a user is able to upload such image data to a remote location or electronic address.

Thus, a user has the ability to re-size, from a client terminal, or other information appliance, an image stored on a remote machine without having to resend the image back to the server. This is accomplished by the user uploading image data from the client terminal to the remote machine. Next the image is displayed on the client terminal from the remote machine. Then, the image is resized on the remote machine based on the dimensions sent from the client terminal to the remote machine. Thus, only the dimensions, and not the entire image, are sent back from the client terminal to the remote machine.

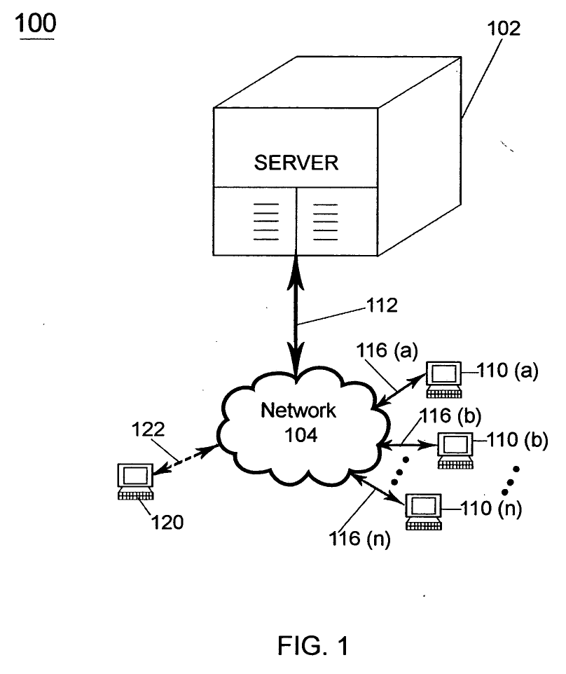

FIG. 1 shows a network environment 100 adapted to support the present invention. The exemplary environment 100 includes a network 104, a server 102, a plurality of communication appliances, or user locations, or subscriber devices, or client terminals, 110(a) . . . (n) (where “n” is any suitable number) (collectively referred to herein as, client terminals 110) and one or more remote client terminals, represented by terminal 120.

The network 104 is, for example, any combination of linked computers, or processing devices, adapted to transfer and process data. The network 104 may be private Internet Protocol (IP) networks, as well as public IP networks, such as the Internet that can utilize World Wide Web (www) browsing functionality.

Server 102 is operatively connected to network 104, via bi-directional communication channel, or interconnector, 112, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between one or more remote modules or devices.

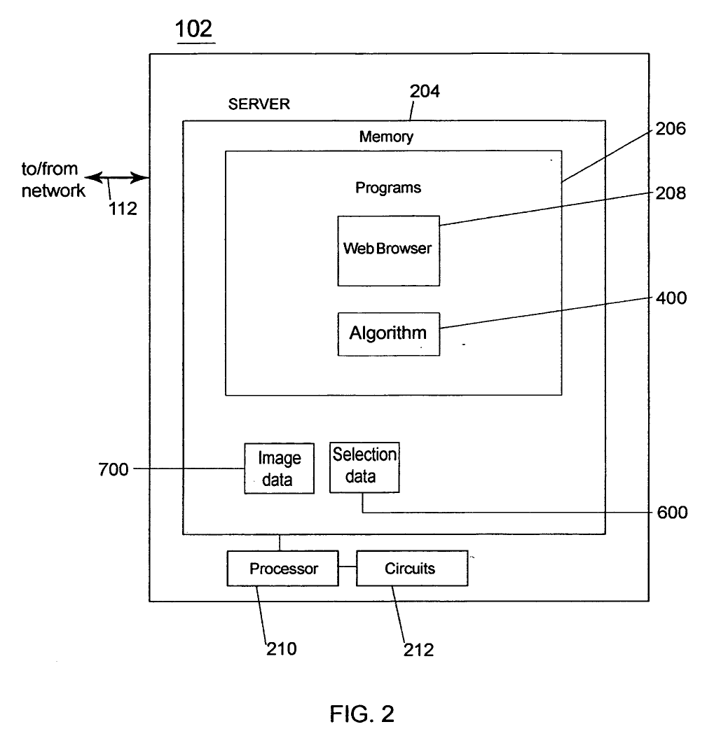

The server 102 is adapted to transmit data to, and receive data from, client terminals 110 and 120, via the network 104. Server 102 is described in more detail with reference to FIG. 2, herein.

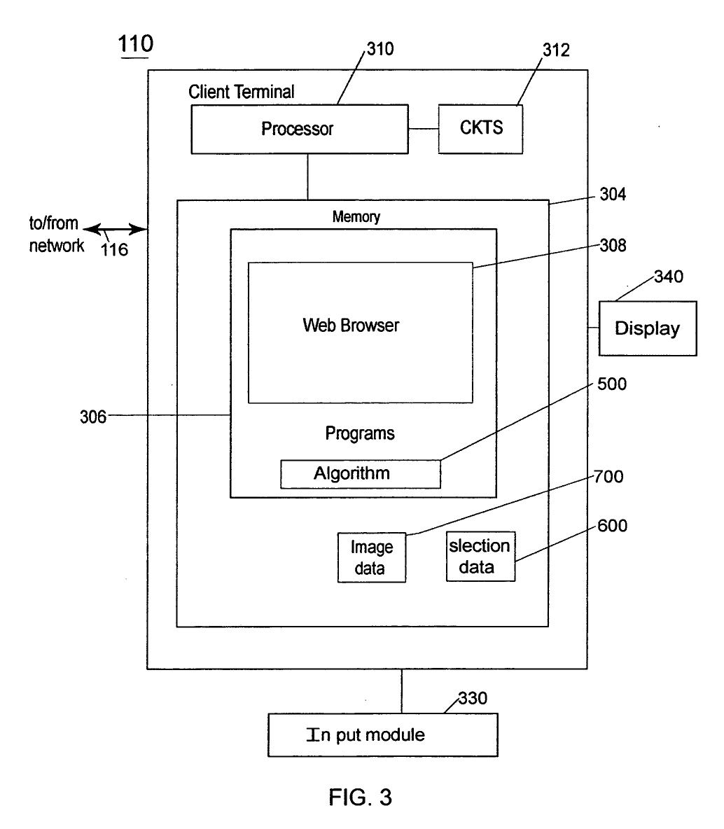

Client terminals 110 and 120 are typically computers, or other processing devices such as a desktop computer, laptop computer, personal digital assistant (PDA), wireless handheld device, and the like. They may be capable of processing and storing data themselves or merely capable of accessing processed and stored data from another location (i.e., both thin and fat terminals). These client terminals 110, 120 are operatively connected to network 104, via bi-directional communication channels 116, 122, respectively, which may be for example a serial bus such as IEEE 1394, or other wire or wireless transmission medium. Client terminals 110, 120 are described in more detail in relation to FIG. 3.

The server 102 and client terminals 110, 120 typically utilize a network service provider, such as an Internet Service Provider (ISP) or Application Service Provider (ASP) (ISP and ASP are not shown) to access resources of the network 104.

FIG. 2 illustrates that server 102, which is adapted to store and process data related to the present invention, is operatively connected to the network (shown as 104 in FIG. 1), via interconnector 112. Server 102 includes a memory 204, processor 210 and circuits 212.

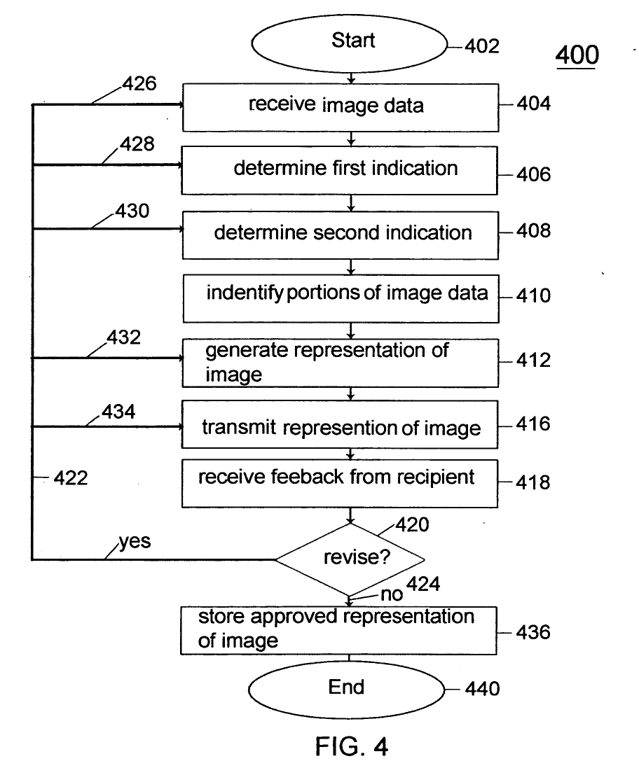

Memory 204 stores programs 206, which include, for example, a web browser 208, an algorithm 400, as well as typical operating system programs (not shown), input/output programs (not shown), and other programs that facilitate operation of server 102. Web browser 208 is for example an Internet browser program such as Explorer™. Algorithm 400 is a series of steps for manipulating selected image data, which is typically stored on a computer-readable memory and executed by a processor. The manipulating process generates a representation of the image data, which may be a reduction, enlargement or movement of the selected portions of the image data. These functions may be implemented or facilitated by using software, such as Adobe™ Photoshop or other program code or software that re-sizes the image data. This algorithm 400 is discussed in more detail in relation to FIG. 4.

Memory 204 also stores data tables 600 and 700. These data tables 600 and 700 are databases or memory locations adapted to store related data, which can be retrieved, processed, updated, modified or otherwise manipulated.

Data table 600 is adapted to store selection data related to user-specified input. This input is typically obtained when a user positions a mouse, or inputs one or more keystroke representations, or other selection means on a portion of image data, using a template such as a mark-up language (ML) template and may also include modified or updated selections made by a user. The mark-up language may be, for example, hypertext mark-up language (HTML) or extensible mark-up language (XML).

Data table 700 is adapted to store the image data, which includes the initial image data, the representation of the initial image data and updated or modified representations that are generated in response to updated or modified selection parameters input by a user.

Processor 210, which is operatively connected to memory 204, is used to process and manipulate the data retrieved and stored by server 102. The processor 210 is typically a microprocessor with sufficient speed and processing capacity to adequately perform the desired data manipulations of server 102. Circuits 212 are operatively connected to processor 210 and typically include, for example, Integrated Circuits (ICs), ASICs (application specific ICs) power supplies, clock circuits, cache memory and the like, as well as other circuit components that assist in executing the software routines stored in the memory 204 and that facilitate the operation of processor 210.

FIG. 3 illustrates subscriber terminal, also referred to herein as a client terminal, user terminal, or communication appliance 110. Terminal 110 is typically a desktop computer, laptop computer, PDA (personal digital assistant), wireless handheld device, mobile phone or other device capable of interfacing with a network, such as an IP network. Terminal 110 includes processor 310, support circuitry 312, memory 304, input module 330 and display module 340. Bi-directional interconnection medium 116 operatively connects the terminal 110 to the network (shown as element 104 in FIG. 1). The user terminal is typically located at the user location.

Processor 310, which is operatively connected to memory 304, is used to process and manipulate the data retrieved and stored by terminal 110. The processor is typically a microprocessor with sufficient speed and processing capacity. The processor 310 is operatively connected to circuitry 312. Circuitry 312 typically includes, for example, Integrated Circuits (ICs), ASICs (application specific ICs) power supplies, clock circuits, cache memory and the like, as well as other circuit components that assist in executing the software routines stored in the memory 304 and that facilitate the operation of processor 310.

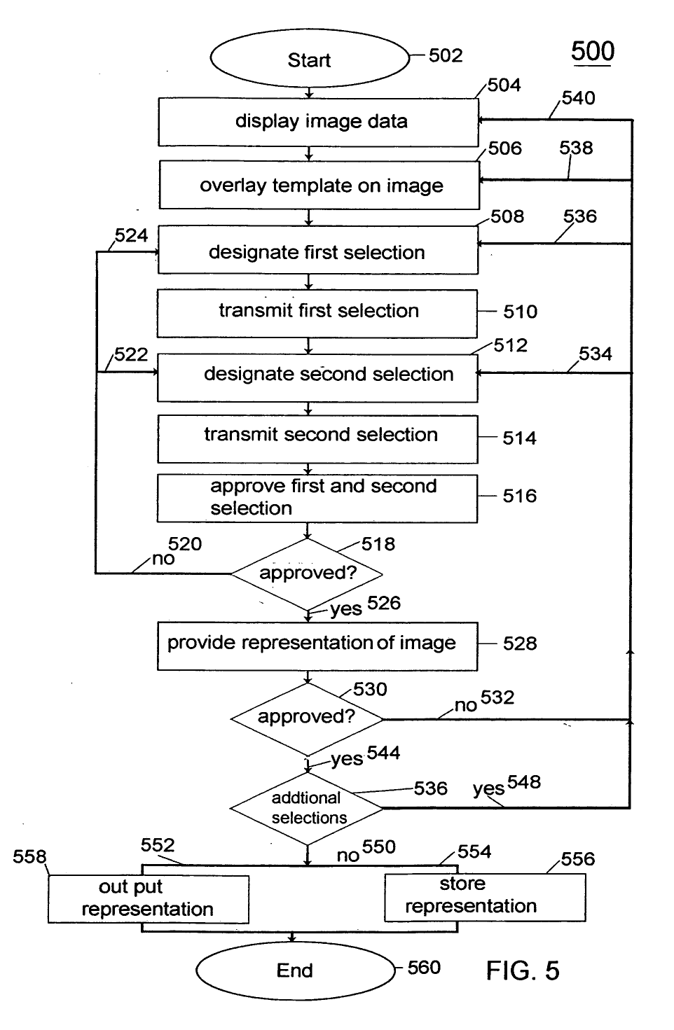

Memory 304 stores programs 306, which include, for example, a web browser 308, an algorithm 500 as well as typical operating system programs (not shown), input/output programs (not shown), and other programs that facilitate operation of terminal 110. Web browser 308 is for example an Internet browser program such as Explorer™. Algorithm 500 is a series of steps, typically executed by a processor such as, for example, processor 310, to manipulate selected image data from the client terminal. This algorithm 500 is discussed in more detail in relation to FIG. 5.

Memory 304 also stores data tables 600 and 700. These data tables 600 and 700 are databases or memory locations adapted to store related data, which can be retrieved, processed, updated, modified or otherwise manipulated.

Data table 600 is adapted to store selection data related to user-specified input. This input is typically obtained when a user positions a mouse, or provides one or more keystrokes, or other selection means on a portion of image data, using a template such as a mark-up language (ML) template. The mark-up language may be, for example, hypertext mark-up language (HTML) or extensible mark-up language (XML).

Data table 700 is adapted to store the image data, which includes the initial image data and the representation of the initial image data and updated or modified representations that are generated in response to updated or modified selection parameters input by a user representation of the initial image data. This data is typically received from a remote location, although, may also be generated at the client terminal 110.

Input module 330 is, for example, a keyboard, mouse, touch pad, menu having soft-keys, or any combination of such elements, or other input facility adapted to provide input to terminal 110.

Display module 340 is, for example, a monitor, LCD (liquid crystal display) display, GUI (graphical user interface) or other interface facility that is adapted to provide or display information to a user.

A general discussion of several embodiments are of the invention are discussed below, with more specific embodiments discussed in relation to FIGS. 4, 5, 6A, 6B and 7.

Generally, the apparatus, system and method of the present invention are achieved in several steps. These include displaying the picture to be re-sized, either cropped, reduced or enlarged, on a web page, or other source of image data, and overlaying an HTML table, or other HTML generated grid or template, on top of the image or picture. The table, which is for example, the product of a web-publishing language, creates a “grid” that comprises a plurality of rectangles and each rectangle in the grid includes a transparent, translucent, opaque or combination of the three, graphical image format (gif), so the picture can be seen completely and without restriction. The grid is typically generated using an HTML language that permits a user to specify a cell height and cell width.

The granularity, or degree of detail of the table is a function of the grid parameters and may be adjusted according to one or more factors, such as size of original image, user-selection, source of image data, desired size of the image after the re-sizing operation, component capability, such as display device capacity and similar criteria.

The user will typically select two opposite corners of the template to indicate desired dimensions of the new picture. Associated software is programmed to keep track of whether the user has already selected one of the corners or not.

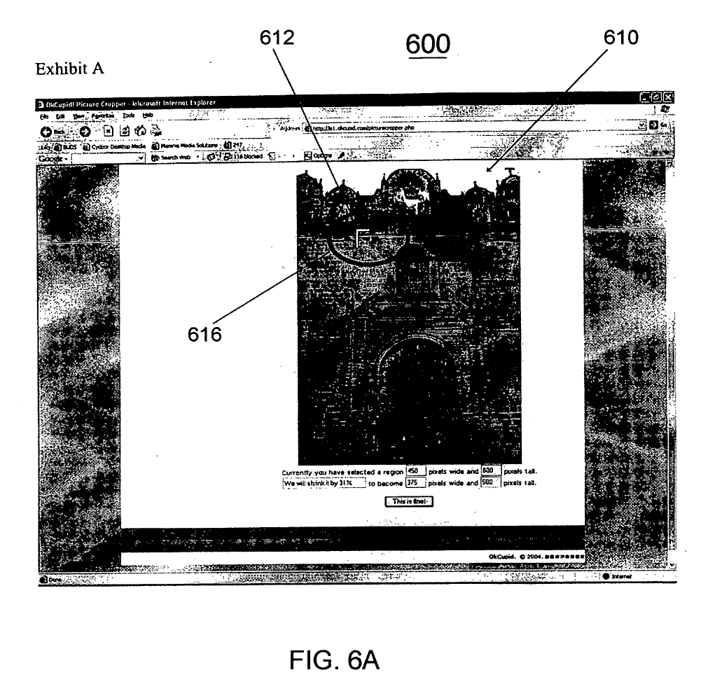

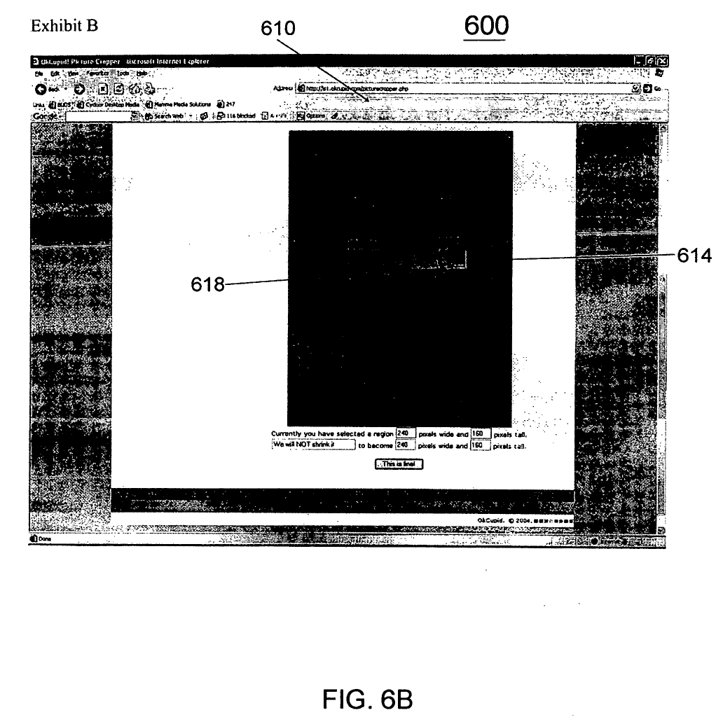

If the user has not selected one of the corners, whenever a user places a mouse, or other selection means, such as a cursor position or series of keystrokes indicating a selection, over a rectangle on the grid, the grid cell is overlayed with a semitransparent marker or replaced with an identical image with the two sides emboldened to indicate where the corner of the new picture would be if that box of the grid were selected. This is described in more detail in relation to FIGS. 6A and 6B. Once a user is satisfied with the new corner placement and clicks the mouse, or otherwise indicates the selection, then that image in the grid is replaced with the emboldened transparent image throughout the remainder of the iteration and the coordinate of that box is stored.

If the user has selected one of the corners, whenever a user uses a mouse, keyboard, rollerball, sequence of keystrokes, touch screen or other indication technique to select a desired location, on a rectangle on the grid, the image in the grid is replaced with an identical transparent image with the opposite two sides emboldened to indicate where the opposite corner of the new picture would be if that box of the grid were selected. Once a user is satisfied with the second corner placement and clicks the mouse, or otherwise indicates approval, the user has defined the rectangle that will be the final re-sized image. The coordinate of his second click is also stored. This is described in more detail in relation to FIGS. 6A and 6B.

Furthermore, an indication can be provided that indicates, to the user, the entire border of the new image. One example is to replace all transparent gifs outside of the cropped range with opaque (or just more opaque) gifs.

It is also an embodiment that the user can be asked to approve the selected image, either prior to the re-sizing or after the re-sizing or both before and after the re-sizing. The user can modify one or both of the selections and retransmit the modified selections to a server or other remote location, or store the modified selections at a user terminal as described herein. In a server embodiment, the coordinates of the selected two corners are posted back to the server where the actual resizing is done using one or more libraries. The newly re-sized picture is then republished to the website, stored in a memory or transmitted to a user terminal or other location, depending on how the user desires to receive the re-sized image data.

As shown in FIG. 4, algorithm 400 is a series of steps, typically stored on a computer-readable medium that may be executed at a server, or other processing device to implement the present invention. As shown in FIG. 4, step 402 begins execution of the algorithm. Image data is received, as shown in step 404. The image data is typically, for example, web page images, photographic data, scanned data or previously stored data. The reception is typically from a user terminal, web page, network device or other source of image data, and is typically transmitted over a network.

Step 406 determines a first indication, which is typically generated by a user, at a remote terminal, using a template overlayed on a portion of the image data and “clicking” on a first portion of the image data using a mouse or series or keystrokes or other selection means to indicate a first position on the image data.

Step 408 determines a second indication, which is also typically generated by a user, at the remote terminal, using the template overlayed on the image data and “clicking” on a second portion of the image data using a mouse or series or keystrokes or other selection means to indicate a second position on the image data.

Step 410 identifies portions of the image data as a function of the first and second indications. This identification is typically accomplished by using the first and second indications as points on a rectangle, or other parallelogram using the grid of the template to generate a portion of the initial image data to be re-sized. The number of points may be modified based on the image data to be re-sized and may include any suitable number.

Step 412 generates a representation of the initial image data by manipulating the initial image data as a function of the selected indications received from a user, which may include modifications, repeated selections or revised selections. The representation can be generated by software such as Adobe™ Photoshop and can be either an enlargement or a reduction or a movement of the selected portions. Thus, at the server, or processing facility, the two, or more, indications are used as data points for manipulation of the image data. This manipulation is typically accomplished using resizing software, or program code.

Step 416 transmits the representation of the image data to a location, such as a user terminal, other location designated by a user, or a memory coupled to the server, or processing device, executing algorithm 400.

When the representation of the image data is transmitted to a location at which the user can view or otherwise approve the representation, the user can provide feedback, which is typically either approval or a request to revise the representation. Step 420 shows that if the representation is deemed to require modification, “yes” line 442 has component lines 426, 428, 430, 432 and 434.

Component line 426 shows that modified initial image data is received. This affords the user the ability to select other image data by repeating the subsequent steps of algorithm 400 (i.e., steps 406, 408, 410, 412, 416 and 418), which have been described above.

Component line 428 shows that the user can modify the first indication. The second indication may remain the same or be modified as well. Similarly, component lines 430, 432 and 434 enable a user to determine at what point they would like to modify or revise the generated representation.

If the user, or recipient of the representation, is satisfied with the representation, and does not wish to revise it, “no” line 424 leads to storage step 436. The storage may be at the server memory, remote memory, user device or other specified memory location.

The algorithm ends, as shown in step 440.

FIG. 5 is an algorithm, executable at a communication appliance, or user terminal, for manipulating selected image data. The algorithm may be stored at the user terminal or accessed by the user terminal, for example over a network, or from a processing or storage facility coupled to the user terminal.

As shown in FIG. 5, algorithm 500 begins with start step 502. Image data is displayed in step 504. This image data is typically displayed on a display module of a user terminal. The image data may be accessed or obtained by the user terminal by scanning a hard copy, receiving the data from a remote location, or other acquisition technique for acquiring data, in an electronic format.

A template, such as a mark-up language template using HTML or XML, is superimposed, or overlayed on a portion of the image data in step 506.

Step 508 shows that a user may designate a first selection. This designation is typically accomplished by the user selecting a first area of the template using a mouse, keystrokes or other selection means. Step 510 shows that the first selection is then transmitted to a processing location, such as a server as described herein.

Alternatively, in an embodiment in which the processing is performed at the user terminal, the first selection is not transmitted to a processing location, but rather is used at the user terminal to perform the manipulation.

A second selection is designated, as shown in step 512. This second selection designation is accomplished using a similar procedure as the first selection, i.e., using the template and selecting a portion of the image data using the template. The second selection may be transmitted to a remote location, such as a server, as shown in step 514.

Similar to the alternate embodiment described in relation to step 510, above, when the user terminal is adapted to perform the manipulation operation, the second selection need not be transmitted to a remote processing facility and step 514 may be omitted.

The first and second selections are approved in step 516. Decision step 518 shows that if the first and second selections are not satisfactory, “no” line 520, with component lines 522 and 524 repeat particular portions of algorithm 500. Specifically, component line 524 permits re-designating the first selection and component line 522 permits re-designating the second selection.

If the first and second selections are approved, “yes” line 526 leads to step 528 in which a representation of the image, which has been manipulated, is provided. This includes, for example, receiving the representation from a remote processing location that performed the processing as well as displaying the representation that was generated at the user terminal, which performed the processing.

A user, or recipient, has an opportunity to approve the representation, as shown in decision step 530. If a user wishes to modify the representation, “no” line 532, which comprises component lines 534, 536, 538 and 540 lead to various processing steps of algorithm 500, which provide the user with associated portions of the algorithm that can be repeated and thereby modify the representation.

If the representation is approved, “yes” line 544 leads to decision step 536, in which a user can make additional selections, if so desired. If additional selections are desired, “yes” line 548 intersects with line 532, having component lines 534, 536, 538 and 540, as described above.

If additional selections are not desired, “no” line 550, with component lines 552 and 554 lead to an output step 558 and a storage step 556, respectively. End step 560 ends the algorithm 500.

FIGS. 6A and 6B show an example of image data 600 that includes an initial image 610 and a first selection 612 and a second selection 614. First selection 612 is a first portion of image 610 and second selection 614 is a second portion of image 610.

Corner representation 616 shows a first corner of a template and corner representation 618 shows a second corner of the template. Corners 616 and 618 are non-identical corners of the template that has been super-imposed on image data 610.

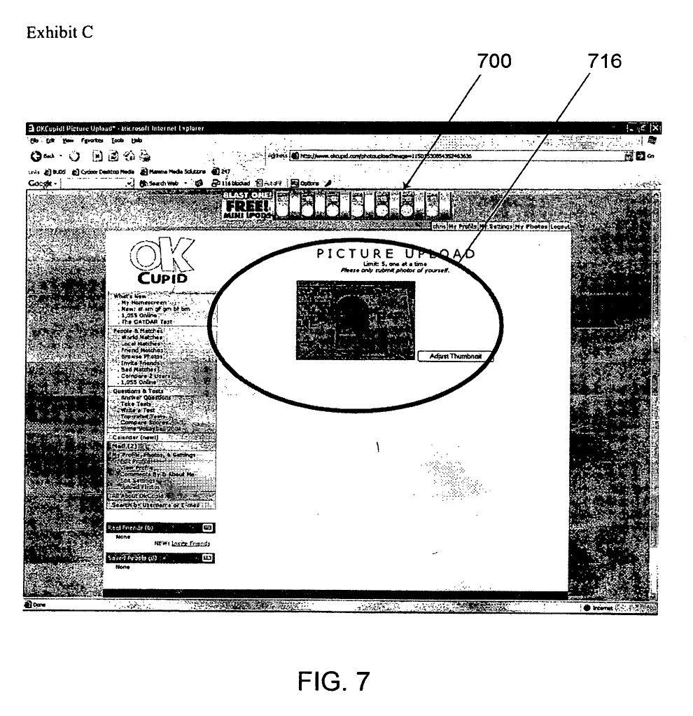

FIG. 7 shows an example of re-sized image data 716, which is generated as a function of the selections shown in FIGS. 6A and 6B.

Thus, while fundamental novel features of the invention shown and described and pointed out, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in another form or embodiment. It is the intention, therefore, to be limited only as indicated by the scope of the claims appended hereto.

What is claimed is:

1. A method for manipulating image data comprising:
displaying the image data;
overlaying a mark-up language template on at least a portion of the image data, the template permitting viewing of the portion of the image data;
selecting at least two parameters of the template indicating dimensions;
transmitting the selected parameters to a remote location; and
receiving a representation of the portion of the image data as a function of the sleeted parameters.

2. The method as claimed in claim 1, further comprising approving, at a user location, the representation.

3. The method as claimed in claim 1, further comprising approving, at a user location, the selected parameters.

4. The method as claimed in claim 1, further comprising:
reselecting the at least two parameters of the template;
transmitting the reselected parameters to the remote location; and
receiving a second representation of the portion of the image data.

5. The method as claimed in claim 1, further comprising storing the representation.

6. The method as claimed in claim 1, wherein the representation represents a re-sizing of image data.

7. The method as claimed in claim 1, wherein the representation represents a reduction of image data.

8. The method as claimed in claim 1, wherein the representation represents a reduction of image data.

9. A method for manipulating image data comprising:
accessing image data at a user location;
overlaying a template on the image data;
specifying a first position of the template;
specifying a second position of the template;
transmitting signals indicative of the specified first position and the specified second position to a processing location; and
receiving a representation of the image data as a function of the specified first position and the specified second position.

10. The method as claimed in claim 9, further comprising approving, at a user location, the representation.

11. The method as claimed in claim 9, further comprising approving, at a user location, the first and second specified positions.

12. The method as claimed in claim 9, further comprising:
reselecting the first and second specified positions;
transmitting the reselected positions to a remote location; and
receiving a second representation of the image data.

13. The method as claimed in claim 9, wherein the representation represents a re-sizing of image data.

14. A method for manipulating image data comprising:
receiving, from a remote location, image data with at least two indications that have been indicated using a template;
identifying portions of the image data as a function of the indications; and
generating a representation of the image data by modifying dimensions of the identified portions.

15. The method as claimed in claim 14, further comprising transmitting the representation to a remote location.

16. The method as claimed in claim 14, further comprising transmitting the representation to a user location.

17. The method as claimed in claim 14, further comprising transmitting the representation to a storage location.

18. An apparatus for manipulating image data comprising:
means for displaying the image data;
means for overlaying a mark-up language template on at least a portion of the image data, the template permitting viewing of the portion of the image data;
means for selecting at least two parameters of the template indicating dimensions;
means for transmitting the selected parameters to a remote location; and
means for receiving a representation of the portion of the image data.

19. The apparatus as claimed in claim 18, further comprising means for approving, at a user location, the representation.

20. The apparatus as claimed in claim 18, further comprising means for approving, at a user location, the selected parameters.

21. The apparatus as claimed in claim 18, further comprising:
means for reselecting the at least two parameters of the template;
means for transmitting the reselected parameters to the remote location; and
means for receiving a second representation of the portion of the image data.

22. The apparatus as claimed in claim 18, further comprising means for storing the representation.

23. The apparatus as claimed in claim 18, wherein the representation represents a re-sizing of image data.

24. The apparatus as claimed in claim 18, wherein the representation represents a reduction of image data.

25. The apparatus as claimed in claim 18, wherein the representation represents a reduction of image data.

26. An apparatus for manipulating image data comprising:
means for accessing image data at a user location;
means for overlaying a template on the image data;
means for specifying a first position of the template;
means for specifying a second position of the template;
means for transmitting signals indicative of the specified first position and the specified second position to a processing location; and
means for receiving a representation of the image data as a function of the specified first position and the specified second position.

27. The apparatus as claimed in claim 26, further comprising means for approving, at a user location, the representation.

28. The apparatus as claimed in claim 26, further comprising means for approving, at a user location, the first and second specified positions.

29. The apparatus as claimed in claim 26, further comprising:
means for reselecting the first and second specified positions;
means for transmitting the reselected positions to a remote location; and
means for receiving a second representation of the image data.

30. The apparatus as claimed in claim 26, wherein the representation represents a re-sizing of image data.

31. An apparatus for manipulating image data comprising:
means for receiving, from a remote location, image data with at least two indications that have been indicated using a template;
means for identifying portions of the image data as a function of the indications; and
means for generating a representation of the image data by modifying dimensions of the identified portions.

32. The apparatus as claimed in claim 31, further comprising means for transmitting the representation to a remote location.

33. The apparatus as claimed in claim 31, further comprising means for transmitting the representation to a user location.

34. The apparatus as claimed in claim 31, further comprising means for transmitting the representation to a storage location.

35. A method for manipulating image data, stored on a computer-readable medium, comprising:
program code for displaying the image data;
program code for overlaying a mark-up language template on at least a portion of the image data, the template permitting viewing of the portion of the image data;
program code for selecting at least two parameters of the template indicating dimensions;
program code for transmitting the selected parameters to a remote location; and
program code for receiving a representation of the portion of the image data.

36. The method as claimed in claim 35, further comprising program code for approving, at a user location, the representation.

37. The method as claimed in claim 35, further comprising program code for approving, at a user location, the selected parameters.

38. The method as claimed in claim 35, further comprising:
program code for reselecting the at least two parameters of the template;
program code for transmitting the reselected parameters to the remote location; and
program code for receiving a second representation of the portion of the image data.

39. The method as claimed in claim 35, further comprising program code for storing the representation.

40. A method for manipulating image data, stored on a computer-readable medium, comprising:
program code for accessing image data at a user location;
program code for overlaying a template on the image data;
program code for specifying a first position of the template;
program code for specifying a second position of the template;
program code for transmitting signals indicative of the specified first position and the specified second position to a processing location; and
program code for receiving a representation of the image data as a function of the specified first position and the specified second position.

41. The method as claimed in claim 40, further comprising program code for approving, at a user location, the representation.

42. The method as claimed in claim 40, further comprising:
program code for reselecting the first and second specified positions;
program code for transmitting the reselected positions to a remote location; and
program code for receiving a second representation of the image data.

43. The method as claimed in claim 40, wherein the representation represents a re-sizing of image data.

44. A method for manipulating image data, stored on a computer-readable medium comprising:
program code for receiving, from a remote location, image data with at least two indications that have been indicated using a template;
program code for identifying portions of the image data as a function of the indications; and
program code for generating a representation of the image data by modifying dimensions of the identified portions.
